(19) United States
(12) Patent Application Publication
(10) Pub. No.: US 2010/0222085 A1
(43) Pub. Date: Sep. 2, 2010

(54) METHODS AND ARRANGEMENTS FOR CREATING A VIRTUAL RELATIONSHIP

(75) Inventor: Kamal EL BEDRAOUI, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/394,907

(22) Filed: Feb. 27, 2009

(51) Int. Cl. H04W 4/12

(52) U.S. Cl. 455/466

(57) ABSTRACT

A system for creating a virtual relationship between communication devices before one of the devices shares private information with the other device. The one device may include an application with a registered account at a server, and the other device may include an application with a registered account at another server. The one device may receive a request to generate an invitation to create a virtual relationship between the devices, the invitation may be generated and sent to the one device. The invitation may be received for acceptance from the other device via the other server in a short messaging service (SMS) message from the one device. The relationship between devices may be created upon receipt of the invitation acceptance from the other device.

### TECHNICAL FIELD

The present invention generally relates to methods and arrangements in a first communication device, a second communication device and a first server and, more particularly, to creating a virtual relationship between communication devices device before the sharing of private information between the communication devices.

### DESCRIPTION OF RELATED ART

In the mobile telecom industry, mobile terminal users frequently access the Internet for services. Internet-based networks are used by individuals to receive and publish information and keep track of a list of business and personal contacts. They provide services such as chatting, voice over Internet Protocol (VOIP), bloging, file transfer and sharing, status updates etc.; well known providers include, Facebook, MSN, MySpace, Hi5, etc.

Mobile terminals users maintain their contact list in different places and register to several service providers in order to reach or get reached by most of his/her contacts. A contact list is a collection of screen names in an instant messaging or e-mail program or online game or mobile phone. Social networks are often centralized and managed by one company. The problem of those centrally managed networks is that they do not offer any interoperability between them. A current solution is to use a multi-protocol client such as e.g. Fring or Nimbuzz that tries to merge services but is very limited in features and hungry in battery consumption, which is not fit for the mobile environment. The problem is that to exchange consistent personal contact information with someone else and register to his/her feed or blog requires a lot of effort.

### SUMMARY

Embodiments of the invention may provide a mechanism for a communication device and a server that makes it easier and/or faster to create a virtual relationship between a first communication device and a second communication device before sharing any and/or particular private information between the first and second communication devices.

According to a first aspect of the invention, a method is performed, in a first communication device, for creating a virtual relationship between the first communication device and a second communication device before sharing private user information. The first communication device comprises an application with a registered account at a first server, and the second communication device comprising an application with a registered account at a second server. The method comprises the following steps to be performed by the application in the first communication device: Sending a request to the first server for generating an invitation to create a virtual relationship between the first communication device and the second communication device, obtaining from the first server, the requested invitation to create a virtual relationship between the first communication device and the second communication device, sending an SMS to the second communication device. The SMS comprises the obtained invitation to create a virtual relationship between the first communication device and the second communication device, and an Internet Protocol “IP” link to the first server. The second communication device can send an invitation acceptance via the second server to the first server. The first server will be triggered to create the virtual relationship between the first communication device

According to other aspects, the first aspect may further include receiving from the first server, a notification that the virtual relationship between the first communication device and the second communication device has been created.

According to yet other aspects, the request to the first server further comprises information about a specific type of relationship associated to the second communication device.

According to further other aspects, a computer program product, in a first communication device, for creating a virtual relationship between the first communication device and a second communication device, comprising computer program code for causing a processing means within a computer placed in the first communication device to control an execution of any of the aspects above, when said code is loaded into the second communication device.

According to a second aspect of the invention, a method is performed, in a second communication device, for creating a virtual relationship between a first communication device and the second communication device before sharing private information. The first communication device comprises an application with a registered account at a first server, and the second communication device comprises an application with a registered account at a second server. The method comprising the steps: Receiving an SMS from the first communication device, the SMS comprising an invitation to create a virtual relationship between the first communication device and the second communication device, and an Internet Protocol “IP” link to the first server, and sending an invitation acceptance and the first server IP link to the second server, which second server forwards the invitation acceptance o the first server. The invitation acceptance comprises the invitation to create a relationship between the first communication device and the second communication device. The invitation acceptance will trigger the first server to create a virtual relationship between the first communication device and the second communication device.

According to other aspects, the second aspect may include sending to the first server, a request for invitation details by using the IP link, and receiving a response from the first server, the response comprising information about specific type of relationship associated to the second communication device.

According to yet other aspects, any of the aspects above may include receiving from the second server, a notification that a virtual relationship between the first communication device and the second communication device has been created.

According to further other aspects, a computer program product, in a first communication device, for creating a virtual relationship between a first communication device and a second communication device, the computer program product comprising computer program code for causing a processing means within a computer placed in the second communication device to control an execution of any of the aspects above, when said code is loaded into the second communication device

According to a third aspect of the invention, a method is performed, in a first server, for creating a virtual relationship between a first communication device and a second communication device before the first communication device shares private information with the second communication device. The first communication device comprises an application with a registered account at the first server, and the second communication device comprising an application with a registered account at a second server. The method comprises the steps of receiving from the first communication device a request to generate an invitation to create a virtual relationship between the first communication device and the second communication device, generating the requested invitation associated to the first communication device account, and sending the generated invitation to the first communication device. The method comprises the further steps of receiving an invitation acceptance from the second communication device via the second server, which invitation acceptance comprises the invitation to create a relationship between the first communication device and the second communication device, which invitation was received by the second communication device in a short message service “SMS” from the first communication device, and creating a relationship between the first communication device and the second communication device, when receiving the invitation acceptance from the second communication device.

According to other aspects, information about a specific type of relationship associated to the second communication device is comprised in the request to generate an invitation, and the generated invitation associated to the first communication device account, further is associated to the specific type of relationship associated to the second communication device.

According to yet other aspects, creating a relationship between the first communication device and the second communication device is performed by: receiving a request from the second server, requesting credential for the second communication device to watch the first communication device user information; creating credential for the second communication device to watch first communication device user information; and sending to the second server the requested credential for the second communication device to watch the first communication device user information

According to further other aspects, any of the aspects above may include receiving from the second communication device, a request for invitation details, and sending a response to the second communication device, the response comprising information about specific type of relationship associated to the second communication device.

According to still other aspects, any of the aspects above may include sending a request to the second server, requesting credential for the first communication device to watch the second communication device user information, and receiving the requested credential for the first communication device to watch the second communication device user information.

According to yet further other aspects, any of the aspects above may include notifying the first communication device that a virtual relationship between the first communication device and the second communication device has been created.

According to still further other aspects, a computer program product in a first server for creating a virtual relationship between a first communication device and a second communication device, the computer program product comprising computer program code for causing a processing means within a computer placed in the first server to control an execution of any of the aspects above, when said code is loaded into the first server.

According to a fourth aspect of the invention, a method is performed, in a second server, for creating a virtual relationship between a first communication device and a second communication device before the first communication device and the second communication device share private information. The first communication device comprises an application with a registered account at a first server, and the second communication device comprises an application with a registered account at a second server. The method comprises the step of receiving from the second communication device an “IP” link to the first server, and an acceptance of an invitation. The invitation and IP link was received by the second communication device in a SMS from the first communication device. The invitation is an invitation to create a virtual relationship between the first communication device and the second communication device. The method comprises the further step of forwarding the invitation acceptance to the first server. The invitation acceptance will trigger the first server to create a virtual relationship between the first communication device and the second communication device.

According to other aspects, the fourth aspect may include receiving a request from the first server, requesting credential for the first communication device to watch the second communication device user information; creating credential for the first communication device to watch second communication device user information; and sending to the first server, the requested credential for the first communication device to watch the second communication device user information

According to yet other aspects, any of the aspects above may include sending a request to the first server, requesting credential for the second communication device to watch the first communication device user information; and receiving from the first server, the requested credential for the second communication device to watch the first communication device user information.

According to further aspects, any of the aspects above may include notifying the second communication device that a virtual relationship between the first communication device and the second communication device has been created

According to still other aspects, a computer program product in a second server for creating a virtual relationship between a first communication and a second communication device, the computer program product comprising computer program code for causing a processing means within a computer placed in the second server to control an execution of any of the aspects above, when said code is loaded into the second server.

According to a fifth aspect of the invention, an arrangement, in a first communication device, creates a virtual relationship between the first communication device and a second communication device before sharing private information. The first communication device comprises an application with a registered account at a first server, and the second communication device comprises an application with a registered account at a second server. The first communication device arrangement comprises a sending unit configured to send a request to the first server for generating an invitation to create a virtual relationship between the first communication device and the second communication device, and a receiving unit configured to obtain from the first server, the requested invitation to create a virtual relationship between the first communication device and the second communication device. The sending unit is further configured to send an SMS to the second communication device. The SMS comprises the obtained invitation to create a virtual relationship between the first communication device and the second communication device, and an Internet Protocol “IP” link to the first server. The second communication device can send an invitation acceptance to the first server via the second server. The first server will be triggered to create the virtual relationship between the first communication device and the second communication device by the received invitation acceptance from the second communication device.

According to other aspects, the receiving unit further is configured to receive from the first server, a notification that a virtual relationship between the first communication device and the second communication device has been created.

According to yet other aspects, the request to the first server further comprises information about a specific type of relationship associated to the second communication device.

According to further other aspects, the first communication device is a mobile phone

According to a sixth aspect of the invention, an arrangement, in a second communication device, creates a virtual relationship between a first communication device and the second communication device before sharing private information. The first communication device comprises an application with a registered account at a first server, and the second communication device comprises an application with a registered account at a second server. The second communication device arrangement comprises a receiving unit configured to receive an SMS from the first communication device. The SMS comprises an invitation to create a virtual relationship between the first communication device and the second communication device, and an Internet Protocol “IP” link to the first server. The second communication device arrangement further comprises a sending unit configured to send an invitation acceptance and the first server IP link to the second server. The second server forwards the invitation acceptance of the first server. The invitation acceptance comprises the invitation to create a relationship between the first communication device and the second communication device. The invitation acceptance will trigger the first server to create a virtual relationship between the first communication device and the second communication device.

According to other aspects, the sixth aspect may include the sending unit further being configured to send to the first server, a request for invitation details by using the IP link, the receiving unit further being configured to receive a response from the first server, the response comprising information about specific type of relationship associated to the second communication device.

According to yet other aspects, the receiving unit further is configured to receive from the second server, a notification that a virtual relationship between the first communication device and the second communication device has been created

According to a seventh aspect of the invention, an arrangement, in a first server, creates a virtual relationship between a first communication device and a second communication device before the first communication device shares private information with the second communication device. The first communication device comprises an application with a registered account at the first server, and the second communication device comprises an application with a registered account at a second server. The first server arrangement comprises a receiving unit configured to receive from the first communication device a request to generate an invitation to create a virtual relationship between the first communication device and the second communication device, and a generating unit configured to generate the requested invitation associated to the first communication device account. The first server arrangement further comprises a sending unit configured to send the generated invitation to the first communication device. The receiving unit is further configured to receive an invitation acceptance from the second communication device via the second server. The invitation acceptance comprises the invitation to create a relationship between the first communication device and the second communication device. The invitation was received by the second communication device in an SMS from the first communication device. The first server arrangement further comprises a creating unit configured to create a relationship between the first communication device and the second communication device, when receiving the invitation acceptance from the second communication device.

According to other aspects, information about a specific type of relationship associated to the second communication device is comprised in the request to generate an invitation, and the generated invitation associated to the first communication device account, further is associated to the specific type of relationship associated to the second communication device.

According to yet other aspects, the receiving unit further is configured to receive a request from the second server, requesting credential for the second communication device to watch the first communication device user information; and the creating unit further is configured to create credential for the second communication device to watch first communication device user information.

According to further other aspects, the receiving unit further is configured to receive from the second communication device, a request for invitation details; and the sending unit further is configured to send a response to the second communication device, the response comprising information about specific type of relationship associated to the second communication device.

According to still other aspects, the sending unit further is configured to send a request to the second server, requesting credential for the first communication device to watch the second communication device user information; and the receiving unit further is configured to receive the requested credential for the first communication device to watch the second communication device user information.

According to yet still other aspects, the sending unit further is configured to notify the first communication device that a virtual relationship between the first communication device and the second communication device has been created.

According to an eighth aspect of the invention, an arrangement, in a second server, creates a virtual relationship between a first communication device and a second communication device before the first communication device and the second communication device share private information. The first communication device comprises an application with a registered account at a first server, and the second communication device comprises an application with a registered account at a second server. The second server arrangement comprises a receiving unit configured to receive from the second communication device an IP link to the first server, and an acceptance of an invitation. The invitation and IP link was received by the second communication device in an SMS from the first communication device. The invitation is an invitation to create a virtual relationship between the first communication device and the second communication device. The second server arrangement further comprises a sending unit configured to forward the invitation acceptance to the first server. The invitation acceptance will trigger the first server to create a virtual relationship between the first communication device and the second communication device.

According to other aspects, the receiving unit further is configured to receive a request from the first server, requesting credential for the first communication device to watch the second communication device user information; the second server arrangement comprising further comprises a creating unit configured to create credential for the first communication device to watch second communication device user information; and the sending unit further being configured to send to the first server, the requested credential for the first communication device to watch the second communication device user information.

According to yet other aspects, the sending unit further is configured to send a request to the first server, requesting credential for the second communication device to watch the first communication device user information; and the receiving unit further is configured to receive from the first server, the requested credential for the second communication device to watch the first communication device user information.

According to further aspects, the sending unit further is configured to notify the second communication device that a virtual relationship between the first communication device and the second communication device has been created.

According to some embodiments, invitations may be sent from the first communication device and accepted by the second communication device in order to publish personal data, while the second server used as a proxy and the first server may ensure a desired level of security and consistent data storage.

Another advantage of the present invention is that no standardization and/or user configuration is required.

A further advantage is that the invention ensures that any service providers, even operators, can offer to host for each subscriber a personal storage and/or a blog, for example.

### BRIEF DESCRIPTION OF THE DRAWINGS

FIG. 1 is a schematic block diagram illustrating a first communication device communicating with a second communication device according to some embodiments;

FIG. 2 is a combined signaling scheme and flowchart illustrating a method according to some embodiments;

FIG. 3 is a flowchart illustrating embodiments of a method in a first communication device;

FIG. 4 is a schematic block diagram illustrating embodiments of an arrangement in a first communication device;

FIG. 5 is a flowchart illustrating embodiments of a method in a second communication device;

FIG. 6 is a schematic block diagram illustrating embodiments of an arrangement in a second communication device;

FIG. 7 is a flowchart illustrating embodiments of a method in a first server;

FIG. 8 is a schematic block diagram illustrating embodiments of an arrangement in a first server;

FIG. 9 is a flowchart illustrating embodiments of a method in a second server; and

FIG. 10 is a schematic block diagram illustrating embodiments of an arrangement in a second server.

### DETAILED DESCRIPTION OF THE INVENTION

In brief, embodiments provide a method to deploy an application responsible of managing contact relationships and authorize the publishing of personal information to a remote server. An application can be used to send and accept invitations in order to publish personal data, while a server system used as a proxy ensures a desired level of security and consistent data storage.

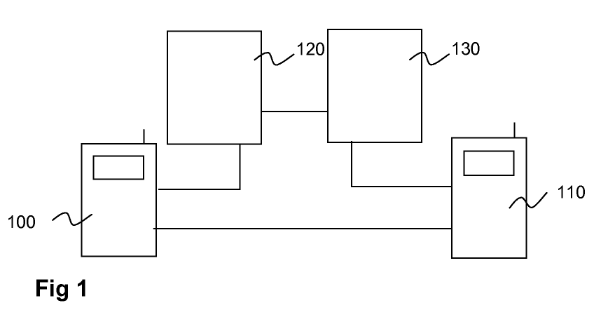

FIG. 1 shows a first communication device 100 adapted to communicate with a second communication device 110. First communication device 100 and second communication device 110 may be comprised in a communication system, such as a radio communication system using technologies, such as global system for mobile communication (GSM) and Wideband Code Division Multiple Access (WCDMA), a Plain Old Telephone Service system (POTS), or the Internet. First communication device 100 and second communication device 110 may be an electronic equipment such as a portable device, a mobile phone, a Personal Digital Computer, a POTS device, a computer or any other communication device comprising a respective telephone number or some other kind of address that make them capable of communicating via Short Message Service (SMS) or similar, using a SMS bearer or similar bearer that may be circuit switched or packet switched. SMS in this document also comprises Multimedia Messaging Service (MMS). For example, first communication device 100 and second communication device 110 may comprise a Subscriber Identity Module (SIM) card or similar function such as Universal Mobile Telecommunication System SIM (USIM) or IP Multimedia Subsystem SIM (ISIM) comprising the telephone number or the other kind of address to the device. The present method uses the feature of a communication system that devices with a SIM card or similar, or a telephone number can directly be contacted as soon as they are turned on, via the SMS (or similar) bearer.

A computer with a SIM (or ISIM or USIM) card can today connect to the internet using, for example, General Packet Radio Service (GPRS), and can send and receive SMS messages using GSM. Such a computer can potentially also be connected to the internet through a landline cable, such as Asymmetric Digital Subscriber Line (ADSL) or a broadband access. With the SIM (or USIM, or ISIM or similar) card it has an identity which makes it reachable. This identity can be its Mobile Station International ISDN Number (MSISDN) number (ISDN stands for Integrated Service Digital Network), such as in the SMS case, or it can be a Session Initiation Protocol Uniform Resource Identifier (SIP URI) as it is the case with ISIM (ISIM is the SIM card application used in the IMS case). The device may send and receive SMS messages over the GSM network or alternatively over the land line cable over the internet with a direct connection to the Short Message Service Center (SMSC).

As indicated above, the service used to connect to the second communication device 110, may be SMS or similar. The SMS service is commonly known and needs no further clarification. It is not unlikely that the SMS service over time is replaced by something else. The unique characteristic of the SMS service is that it is always available as soon as the SIM (or USIM or ISIM) card is installed into the device. A similar service should have the same characteristics but can be more efficiently implemented by using, for example, the SIP URI identity instead of the MS ISDN. This present invention also covers alternative services to SMS.

The present method may further make use of an SMS feature defined in some communication systems, such as radio communication systems, which directly addresses a specified port, not appearing in the device's normal SMS inbox and thereby auto start certain applications. Second communication device 110 further supports download of applications such as Java or UIQ devices. JAVA is an object-oriented programming language developed at Sun Microsystems. The Java language is used extensively on the World Wide Web (www). UIQ 3 is a software platform, pre-integrated and tested with the operating system Symbian OS v9, providing core technologies and services, such as telephony and networking.

First communication device 100 may include a first application with a registered account at a first server 120. The first application is authenticated to first server 120. First communication device 100 has obtained the first application, for example, from a first provider via the authenticated first server 120. The first application is also referred to as the application in the first communication device. Second communication device 110 may include a second application with a registered account at a second server 130. The second application is authenticated to second server 130. The second application is also referred to as the application in second communication device 110. Second communication device 110 has obtained the first application e.g. from a second provider via the authenticated second server 130. The first application and the second application are of the same type and are capable of enabling automatic registration to a default server and start exchange of information between first communication device 100 and second communication device 110. The first and second application may be an application of the type that can be downloaded from e.g. a server. The first application and the second application will be denoted “the application” further on. The application may be written in any open environment such as in e.g. Java or UIQ, making it possible to install the application. The application may be such that it enables real time communication between first communication device 100 and second communication device 110, e.g., voice, pictures, video or any other communication.

A typical scenario is when the users of the two devices, such as first communication device 110 and second communication device 110, want to exchange their contact information, one invites and the other one accepts.

First communication device 110 may invite second communication device 110 to share some information in first server 120, i.e., the default server of first communication device 110.

The application in a device commonly connects to its default server or provider server from which it was originated. If the application in a device receives an invitation with a link to the first server via SMS, it will transmit the entire link to its default server, and this one will connect to the first server if they are different. This is because the default server will act as a proxy for the application, which cannot be a direct actor since it does not have a fixed IP when deployed in today's devices.

User information being managed through the application may be a set of data comprising, for example, name and address information, birthday, phone numbers, uniform resource locators (URLs), logos, photographs, audio clips etc. which are first loaded from the contacts stored in first communication device 100.

Each set of data may then be associated with a type of relationship defined by the user or defined by default such as “family”, “friends” and “co-workers” for sharing of different type of information on the first server 120. For example a picture of a child may be shared in the “family” group, a greeting from a vacation trip may be shared in the “friends” group and an email may be visible to the group “co-workers.”

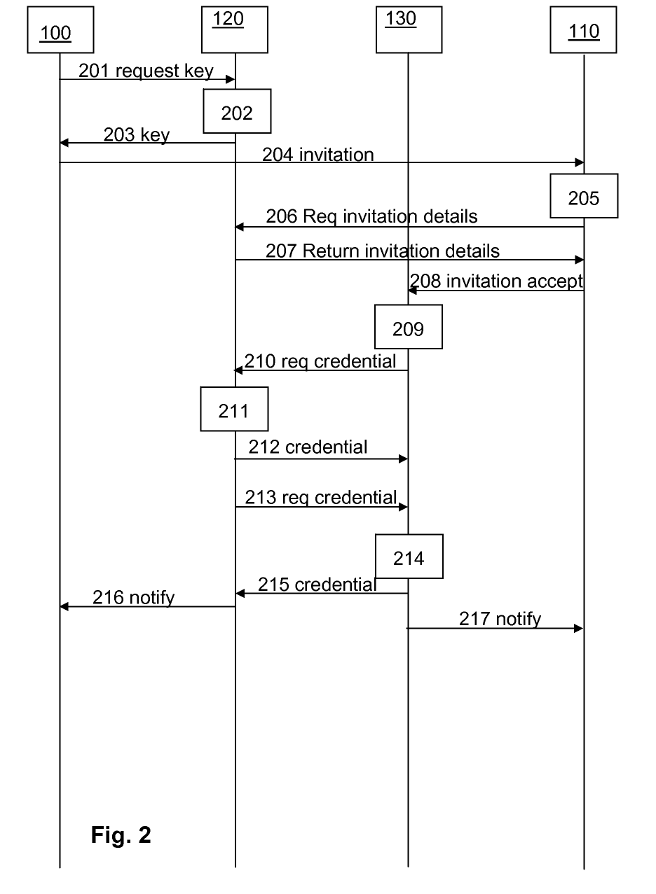

FIG. 2 is a combined signaling scheme and flowchart describing a method for creating a virtual relationship between first communication device 100 and second communication device 110. The method may comprise the following steps:

201. First communication device 100 comprises the first application, it is running and authenticated to first server 120. First communication device 100 sends a request to first server 120 requesting to create an invitation key for a new contact possibly associated with a specific relation type such as e.g. “family.” This step may be performed by the first application. In some embodiments, the first application will display a menu with “Invite as” and then several options such as “friend”, “co-worker,” etc. Therefore, the relationship with second communication device user may be set and accepted by first communication device 100 initially in this step.

202. First server 120 associates the invitation of the new contact and possibly its relation type with a user account of first communication device 110. A user account is used by a server to store data and authenticate the owner of the data. Its a memory space and a database entry with authentication credentials. A communication device may require an account by a service provider in order to proceed in inviting someone else. First server 120 creates an invitation key and a credential that will be used to access private information of first communication device 100. The invitation key generated by first server 120 may be a sequence of character that can be sent in a SMS message which sequence may be about 16-64 character long, and will be used later to authorize second communication device 110 to access private data of first communication device 100. For each communication device, first server 120 may manage a table of authorizations with relation types and their keys.

203. First server 120 may reply by sending the created invitation key to first communication device 100. The invitation key may be temporary, to increase security by limiting the number of pending invitations. The keys may be valid for a short period of time, such as 1-24 hours.

204. First communication device 100 obtains the invitation key from first server 120. First communication device 100 sends an SMS to second communication device 110. The SMS comprises an invitation to create a virtual relationship and the obtained invitation key. The invitation further comprises a link to the default server of the first communication device 100, i.e., to first server 120. This link may be an IP link and may be the URL to first server 120. In some embodiments, it is the first application in first communication device 100 that generates the SMS. The invitation is sent to confirm a relationship and by sending the SMS to second communication device 110, first communication device 100 accepts to make some personal information visible.

205. Second communication device 110 receives the SMS. As mentioned above, the application in second communication device 110 comprises a registered account at second server 130, i.e., the application is authenticated to second server 130. The SMS may be received by the application in second communication device 110 listening on a specific port. The application is started if not already running. The application is authenticated to second server 130. The second application may be started by itself, triggered by the SMS. According to some embodiments, when the second application was installed it “associates” itself to a SMS port, then by receiving a SMS to this particular port, second communication device 110 starts the application and may then call a message listener where the SMS will be parsed.

206. In some embodiments first communication device 110 uses the invitation key and the link to first server 120 comprised in the received SMS to send a request to first server 120 requesting invitation details. This may be performed by the second application.

207. First server 120 may send to second communication device 110, as a response to the request in step 406, invitation details such as inviter name, group, the invitation expiring date and the proposed relation type. Some other details may include the inviter service provider.

208. Second communication device 110 sends to second server 130 the invitation key and the link to first server 120, to notify second server 130 that an invitation has been received. This may be performed by the second application. This is an invitation acceptance and second server 130 is in this step notified to accept handshake. The client application commonly connects directly to its default server. If the other party has another default server the full URL, i.e., IP link is used when connecting to the clients own server indicating which server that in turn should connect to. In those cases the client's own default server acts as a proxy when connecting to the server of the other user.

209. Second server 130 may create an invitation for first communication device 100 to watch the second communication device user information. Since this is a conditional invitation, second server 130 may to create an invitation for the first user account.

210. Second server 130 may send a request to first server 120 requesting credential for invitation for second communication device 110 to watch the first communication device user information and may further send the created invitation for first communication device 100 to watch the second communication device user information. Second server 130 may further request first server 120 what information such as type of relationship, username, etc. the invitation is associated with.

211. First server 120 receives the request and creates credential such as a password, to watch the first communication device user information as a remote reference. This means that first server 120 will create a way to access the first communication device user information or data by another server, i.e., second server 130 that can provide the right password. In this way the first communication device user data will be accessed remotely through an authentication process. However, in some embodiments first server 120 is free to optimize the authentication process, e.g., by linking user tables directly, because if two users want to share information or data stored at the same hosting provider, it is a trusted environment where some operations are not required.

212. First server 120 sends to second server 130, the created credential to watch the first communication device user information.

213. First server 120 further sends a request to second server 130, requesting credential to watch the second communication device user information.

214. Second server 130 receives the request and creates a credential associated with the second communication device account, i.e., for first communication device 100 to watch the second communication device user information, and in some embodiments the second communication device relationship with first communication device 100.

215. Second server 130 sends to first server 120, the created credential for the first communication device to watch the second communication device user information, i.e. the credential that will be used by first communication device 100 to access second communication device user information.

216. First server 120 may send to first communication device 100, a notification that the contact list has been updated with the new second communication device contact.

217. Second server 130 may send to second communication device 110, a notification that the contact list has been updated with the new first communication device contact. i.e., each server may notify the users of respective first communication device 100 and second communication device 110 that the contact list has been updated and they can both download the visible part of each personal information.

At this point, the handshake is done. The users of respective first communication device 100 and second communication device 110, can now watch each others visible information.

If first server 120 and second server 130 are the same, the handshake may be simplified by persisting the credentials and relations locally within the same transaction.

When the user of first communication device 100 wants to publish something such as a photo or a text, or notify that his/her contact information has changed then the application in first communication device 100 sends this to first server 120 which persist it as a new feed entry such as e.g. a blog entry with access rights.

For example, if the user of the first communication device 100 wants to distribute a new feed, e.g., to say “Hello” to all the users of the devices in the “Family” group comprising the user of the second communication device 110:
The first application in first communication device 100 authenticates to first server 120 and sends the text “Hallo” associated to the relationship type “family group” to the first server 120. The first communication device application account may have a username and password, the server is responsible of authenticating its users (for example form, basic, rsa certificate . . . .)
First server 120 will store this information and for each authorized credential will set a flag showing that there is something to download. This may be performed by incrementing the version of the personal database so others can know there is something new to download.
In order to read data from the first user, second communication device 110 will use its second server 130 as a proxy and request if there is something to download in the first user account. Second server 130 will then use the credential and URL (stored previously) to connect to the first server 120 and request the version number of the database. If there are things to download and each device in the family group including second communication device 110, may receive and display the new text messages provided that they request for it.

Note that in this solution there is no central server but many servers and clients, i.e., communication devices such as first communication device 100 and second communication device 110 who all implement the same protocol of creating/accepting/rejecting an invitation, and publish/read content.

A device such as second communication device 110 may track their invitations statuses and cancel whenever wanted.

A device such as second communication device 110 may update their relationship and wait for the first communication device to accept that change.

The application in first communication device 100 and second communication device 110 may be configured to publish automatically calendar entries, location changes, etc.

A device such as second communication device 110 may accept to register to any other source of feeds (blogs, news channels, etc.).

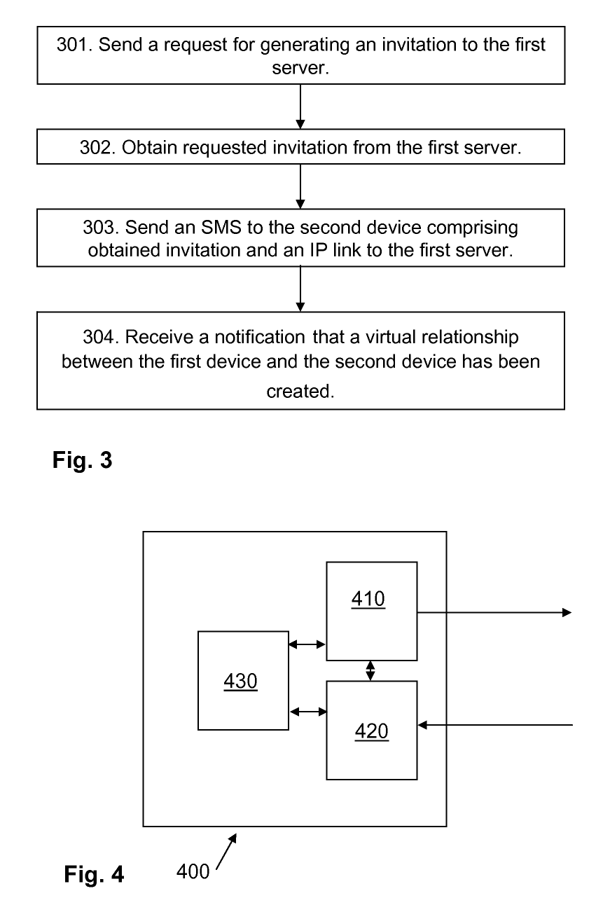

The method described above will now be described seen from the perspective of first communication device 100. FIG. 3 is a flowchart describing the present method in first communication device 100, for creating a virtual relationship between first communication device 100 and second communication device 110 before sharing private user information. As mentioned above first communication device 110 comprises an application with a registered account at first server 120 and second communication device 110 comprises an application with a registered account at second server 120. The method comprises steps to be performed by the application in first communication device 100:

301. First communication device 100 sends a request to first server 120 for generating an invitation to create a virtual relationship between first communication device 100 and second communication device 110.

In some embodiments the request to first server 120 further comprises information about a specific type of relationship associated to second communication device 110.

302. First communication device 100 obtains from first server 120, the requested invitation to create a virtual relationship between first communication device 100 and second communication device 110. This invitation is referred to as invitation key above.

303. First communication device 100 then sends an SMS to second communication device 110. The SMS comprises the obtained invitation to create a virtual relationship between the first communication device and the second communication device. The SMS further comprises an IP link to first server 120. Second communication device 110 can send an invitation acceptance. First server 120 will be triggered to create the virtual relationship between first communication device 100 and second communication device 120 when receiving the invitation acceptance from second communication device 110. The application can be downloaded into the second communication device from first server 120 if second communication device 110 does not comprise the application, which application is required to create the virtual relationship.

304. First communication device 100 receives from the first server, a notification that a virtual relationship between the first communication device and the second communication device has been created.

To perform the method steps above, for creating a virtual relationship between the first communication device and a second communication device before sharing private information, first communication device 100 comprises an arrangement 400 depicted in FIG. 4. An arrangement in this document may be referred to as an apparatus. As mentioned above, first communication device 100 comprises an application with a registered account at first server 120, and second communication device 110 comprises an application with a registered account at second server 130. In some embodiments, first communication device 100 is a mobile phone.

First communication device arrangement 400 comprises a sending unit 410 configured to send a request to first server 120 for generating an invitation to create a virtual relationship between first communication device 100 and second communication device 110. The request to first server 120 may further comprise information about a specific type of relationship associated to second communication device 110.

Sending unit 410 is further configured to send a short message service “SMS” to the second communication device. The SMS comprises the obtained invitation to create a virtual relationship between first communication device 100 and second communication device 110, and an Internet Protocol “IP” link to the first server 120, to which first server the second communication device can send an invitation acceptance via the second server 130. First server 120 will be triggered to create the virtual relationship between first communication device 100 and second communication device 110 by the received invitation acceptance from second communication device 110.

First communication device arrangement 400 further comprises a receiving unit 420 configured to obtain from first server 120, the requested invitation to create a virtual relationship between first communication device 100 and second communication device 110.

In some embodiments, receiving unit 420 further is configured to receive from first server 120, a notification that a virtual relationship between the communication device 100 and second communication device 110 has been created.

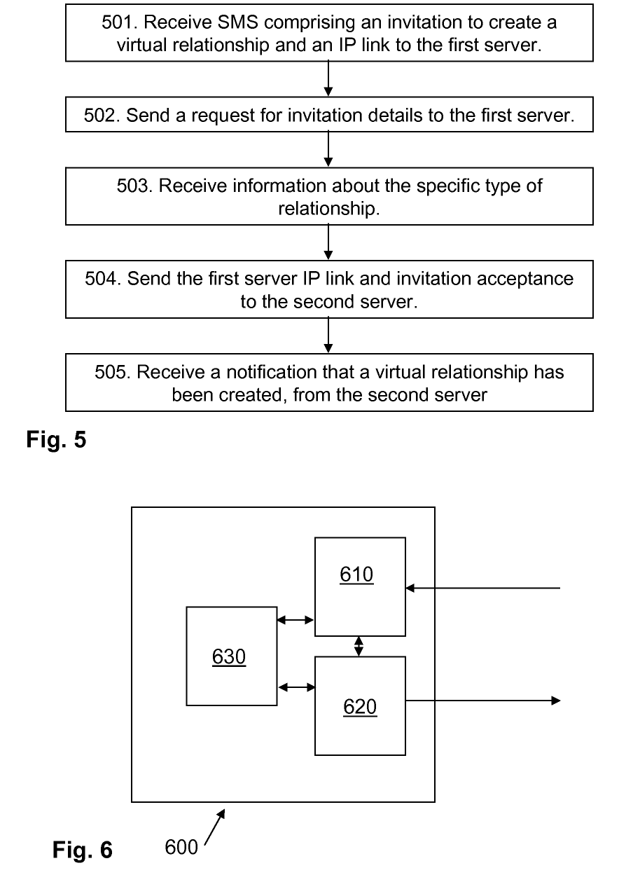

The method described above will now be described seen from the perspective of second communication device 110. FIG. 5 is a flowchart describing the present method in second communication device 110, for creating a virtual relationship between first communication device 100 and second communication device 110 before sharing private user information. As mentioned above the first communication device 110 comprises an application with a registered account at first server 120 and second communication device 110 comprises an application with a registered account at second server 120. The method comprises the further steps which may be taken by the application in second communication device 110:

501. Second communication device 110 receives an SMS from first communication device 100. The SMS comprises an invitation to create a virtual relationship between first communication device 100 and second communication device 110. The SMS further comprises an IP link to first server 120. This invitation is referred to as invitation key above.

502. Second communication device 110 may send a request for invitation details to the first server 120 by using the IP link.

503. The second communication device 110 may receive a response from first server 120. The response comprises information about the specific type of relationship associated to second communication device 110.

504. Second communication device 110 sends to second server 130, an invitation acceptance and the first server IP link, which second server 130 forwards the invitation acceptance of first server 120. The invitation acceptance comprises the invitation to create a relationship between the first communication device and the second communication device. The invitation acceptance will trigger first server 120 to create a virtual relationship between first communication device 100 and second communication device 120.

505. Second communication device 110 may receive from second server 130, a notification that a virtual relationship between first communication device 100 and second communication device 110 has been created.

To perform the method steps above, for creating a virtual relationship between the first communication device and a second communication device before sharing private information, second communication device 110 comprises an arrangement 600 depicted in FIG. 6. As mentioned above first communication device 100 comprises an application with a registered account at first server 120, and second communication device 110 comprises an application with a registered account at second server 130. In some embodiments, second communication device 110 is a mobile phone.

The second communication device arrangement comprises a receiving unit 610 configured to receive a short message service “SMS” from first communication device 100. The SMS comprises an invitation to create a virtual relationship between first communication device 100 and second communication device 110, and an Internet Protocol “IP” link to first server 120.

The receiving unit 610 may further be configured to receive from second server 130, a notification that a virtual relationship between first communication device 100 and second communication device 110 has been created.

The second communication device arrangement comprises a sending unit 620 configured to send an invitation acceptance and the first server IP link to second server 130. Second server 130 forwards the invitation acceptance of first server 120. The invitation acceptance comprises the invitation to create a relationship between first communication device 100 and second communication device 110. The invitation acceptance will trigger first server 120 to create a virtual relationship between first communication device 100 and second communication device 110.

Sending unit 620 may further be configured to send to first server 120, a request for invitation details by using the IP link. Receiving unit 610 may further be configured to receive a response from first server 120. The response may include information about specific type of relationship associated to the second communication device.

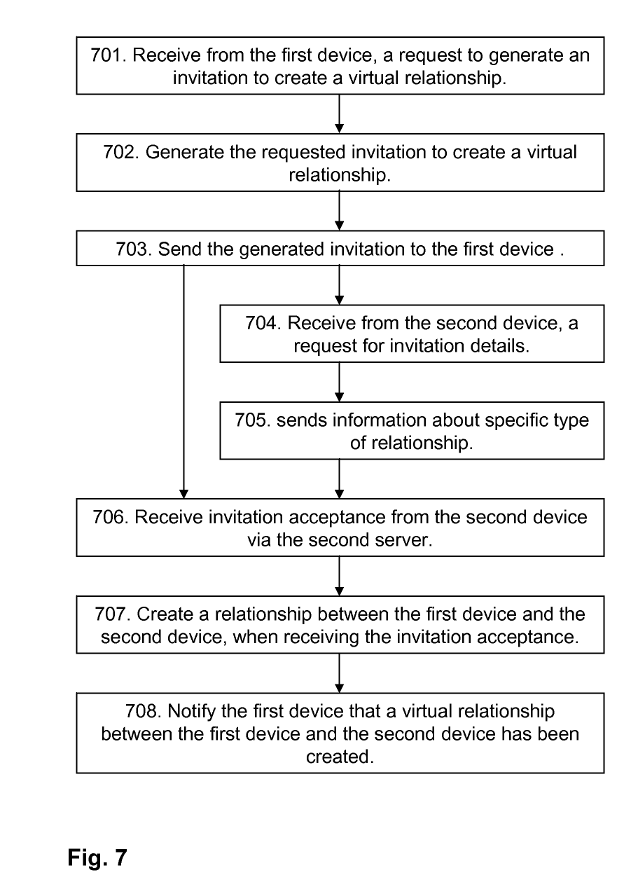

The method described above will now be described seen from the perspective of first server 120. FIG. 7 is a flowchart describing the present method in the first server 120, for creating a virtual relationship between first communication device 100 and second communication device 110 before first communication device 100 shares private information with second communication device 110. As mentioned above first communication device 100 comprises an application with a registered account at first server 120 and second communication device 110 comprises an application with a registered account at second server 130. The method comprises the steps of:

701. First server 120 receives from first communication device 100, a request to generate an invitation to create a virtual relationship between first communication device 100 and second communication device 110. This invitation is referred to as invitation key above.

In some embodiments information about a specific type of relationship associated to second communication device 110 is comprised in the request to generate an invitation.

702. First server 120 generates the requested invitation and associates it to the first communication device account.

In the embodiments wherein information about a specific type of relationship associated to second communication device 110 was comprised in the request to generate an invitation, the generated invitation further is associated to the specific type of relationship associated to second communication device 110.

703. First server 120 sends the generated invitation to first communication device 100.

704. First server 120 receives from second communication device 110, a request for invitation details.

705. First server 120 sends a response to second communication device 110. The response comprises information about specific type of relationship associated to second communication device 110.

706. First server 120 receives an invitation acceptance from second communication device 110 via second server 130. The invitation acceptance comprises the invitation to create a relationship between first communication device 100 and second communication device 110, which invitation was received by second communication device 110 in a short message service “SMS” from first communication device 100.

707. First server 120 creates a relationship between first communication device 100 and second communication device 110, when receiving the invitation acceptance from second communication device 110. The step of creating a relationship between first communication device 100 and second communication device 110 may be performed first server 120 receiving a request from second server 130, requesting credential for second communication device 110 to watch the first communication device user information, creating credential for second communication device 110 to watch first communication device user information, and sending to second server 130 the requested credential for the second communication device to watch the first communication device user information. The step of creating a relationship between the first communication device and the second communication device may further comprise that first server 120 sends a request to second server 130, requesting credential for first communication device 110 to watch the second communication device user information and that first server 120 receives the requested credential for first communication device 100 to watch the second communication device user information.

708. First server 120 may notify first communication device 100 that a virtual relationship between first communication device 100 and second communication device 110 has been created.

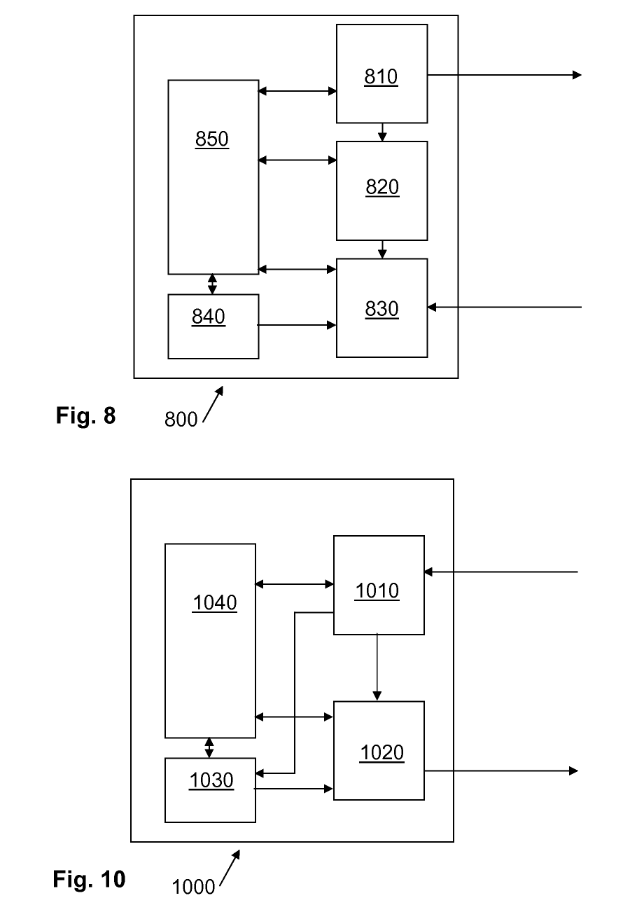

To perform the method steps above, for creating a virtual relationship between the first communication device and a second communication device before sharing private information, first server 120 comprises an arrangement 800 depicted in FIG. 8. As mentioned above, first communication device 100 comprises an application with a registered account at first server 120 “the first communication device account,” and second communication device 110 comprises an application with a registered account at second server 130.

First server arrangement 800 comprises a receiving unit 810 configured to receive from first communication device 100 a request to generate an invitation to create a virtual relationship between first communication device 100 and second communication device 110.

In some embodiments, information about a specific type of relationship associated to second communication device 110 is comprised in the request to generate an invitation.

In some embodiments, receiving unit 810 is further configured to receive a request from second server 130, requesting credential for second communication device 110 to watch the first communication device user information.

First server arrangement 800 further comprises a generating unit 820 configured to generate the requested invitation associated to the first communication device account.

In some embodiments, the generated invitation associated to the first communication device account, further is associated to the specific type of relationship associated to second communication device 110.

First server arrangement 800 further comprises a sending unit 830 configured to send the generated invitation to first communication device 100.

Receiving unit 810 is further configured to receive an invitation acceptance from second communication device 110 via second server 130. The invitation acceptance comprises the invitation to create a relationship between first communication device 100 and second communication device 110, which invitation was received by second communication device 110 in an short message service “SMS” from first communication device 100.

First server arrangement 800 further comprises a creating unit 840 configured to create a relationship between first communication device 100 and second communication device 110, when receiving the invitation acceptance from second communication device 110.

Receiving unit 810 may further be configured to receive from second communication device 100, a request for invitation details.

Sending unit 830 may further be configured to send a response to second communication device 110. The response comprises the information about the specific type of relationship associated to second communication device 110.

Receiving unit 810 may further be configured to receive a request from second server 130, requesting credential for second communication device 110 to watch the first communication device user information.

Creating unit 840 may further be configured to create credential for second communication device 110 to watch first communication device user information.

In some embodiments, sending unit 830 further is configured to send a request to second server 130, requesting credential for the first communication device to watch the second communication device user information.

In these embodiments the receiving unit further may further be configured to receive the requested credential for first communication device 100 to watch the second communication device user information.

In some embodiments, sending unit 830 further is configured to notify first communication device 100 that a virtual relationship between first communication device 100 and second communication device 110 has been created.

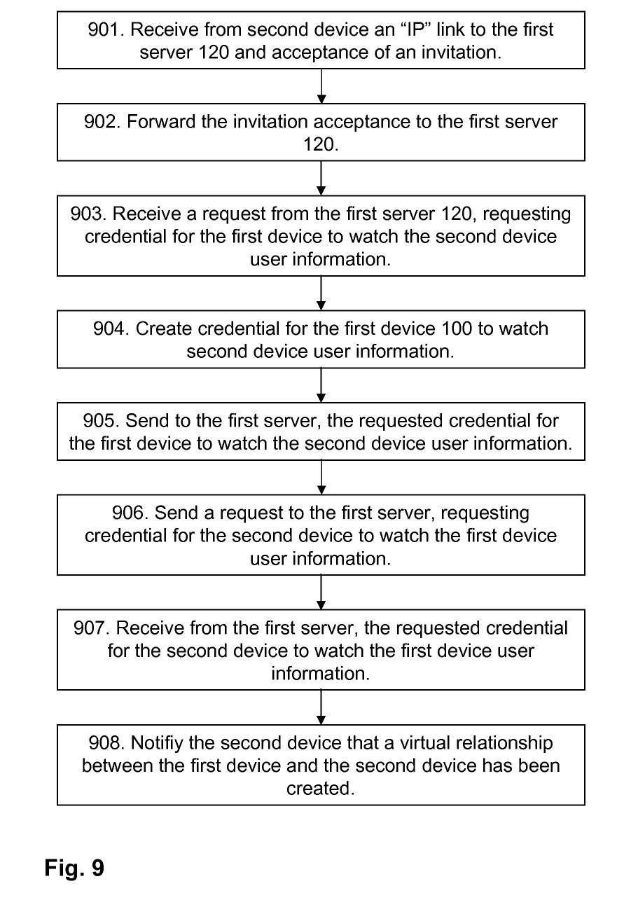

The method described above will now be described seen from the perspective of the second server 130. FIG. 9 is a flowchart describing the present method in second server 130, for creating a virtual relationship between first communication device 100 and second communication device 110 before first communication device 100 shares private information with second communication device 110. As mentioned above first communication device 100 comprises an application with a registered account at first server 120 and second communication device 110 comprises an application with a registered account at second server 130. The method comprises the steps of:

901. Second server 130 receives from second communication device 110 an “IP” link to first server 120 and an acceptance of an invitation. The invitation and IP link was received by second communication device 110 in a short message service “SMS” from first communication device 100. The invitation is an invitation to create a virtual relationship between first communication device 100 and second communication device 110.

902. Second server 130 forwards the invitation acceptance to first server 120. The invitation acceptance will trigger the first server to create a virtual relationship between first communication device 100 and second communication device 110.

903. Second server 130 receives a request from first server 120, requesting credential for first communication device 100 to watch the second communication device user information.

904. Second server 130 creates credential for the first communication device 100 to watch second communication device user information.

905. Second server 130 sends to first server 120, the requested credential for first communication device 100 to watch the second communication device user information.

906. Second server 130 sends a request to first server 120, requesting credential for second communication device 110 to watch the first communication device user information.

907. Second server 130 receives from first server 120, the requested credential for second communication device 110 to watch the first communication device user information.

908. Second server 130 may notify second communication device 110 that a virtual relationship between first communication device 100 and second communication device 110 has been created.

To perform the method steps above, for creating a virtual relationship between the first communication device and a second communication device before sharing private information, the second server 130 comprises an arrangement 1000 depicted in FIG. 10. As mentioned above the first communication device 100 comprises an application with a registered account at the first server 120, and the second communication device 110 comprises an application with a registered account at the second server 130.

Second server arrangement 1000 comprises a receiving unit 1010 configured to receive from second communication device 110 an “IP” link to first server 120, and an acceptance of an invitation. The invitation and IP link was received by second communication device 110 in a short message service “SMS” from first communication device 100. The invitation is an invitation to create a virtual relationship between first communication device 100 and second communication device 110.

Receiving unit 101 may further be configured to receive a request from first server 120, requesting credential for first communication device 100 to watch the second communication device user information.

Second server arrangement 1000 further comprises a sending unit 1020 configured to forward the invitation acceptance to first server 110. The invitation acceptance will trigger first server 120 to create a virtual relationship between first communication device 100 and second communication device 110.

Sending unit 1020 may further be configured to notify second communication device 110 that a virtual relationship between first communication device 100 and second communication device 110 has been created.

Second server arrangement 1000 may further comprise a creating unit 1030 configured to create credential for first communication device 100 to watch second communication device user information.

Sending unit 1020 may further be configured to send to the first server, the requested credential for first communication device 100 to watch the second communication device user information.

In some embodiments, sending unit 1020 is further configured to send a request to first server 120, requesting credential for second communication device 110 to watch the first communication device user information.

In these embodiments, receiving unit 1010 may further be configured to receive from first server 120, the requested credential for second communication device 110 to watch the first communication device user information.

The present application sharing mechanism can be implemented through one or more processors, such as processor 430 in first communication device 100 depicted in FIG. 4, processor 630 in second communication device 110 depicted in FIG. 6, processor 850 in first server 120 depicted in FIG. 8, or processor 1040 in second server 130 depicted in FIG. 10, together with computer program code for performing the functions of the invention. The program code mentioned above may also be provided as a computer program product, for instance in the form of a data carrier carrying computer program code for performing the present method when being loaded into the first communication device 100, in the second communication device 110, in first server 120 or in second server 130. One such carrier may be in the form of a CD ROM disc. It is however feasible with other data carriers such as a memory stick. The computer program code can furthermore be provided as pure program code on a server and downloaded to first communication device 100, second communication device 110, first server 120 and/or second server 130 remotely.

The present invention is not limited to the above-described embodiments. Various alternatives, modifications, and equivalents may be used. Therefore, the above embodiments should not be taken as limiting the scope of the invention, which is defined by the appended claims.

What is claimed is:

1. In a first communication device, a method of creating a virtual relationship between the first communication device and a second communication device before any private user information is shared between the first and second communication devices, the first communication device including an application with a registered account at a first server, and the second communication device including an application with a registered account at a second server, the method comprising:
sending a request to the first server for generating an invitation to create the virtual relationship between the first communication device and the second communication device;
obtaining from the first server, the requested invitation to create the virtual relationship between the first communication device and the second communication device; and
sending a short message service (SMS) to the second communication device, the SMS including the obtained invitation to create a virtual relationship between the first communication device and the second communication device, and an Internet Protocol (IP) link to the first server, to which first server the second communication device can send an invitation acceptance via the second server, and which first server will be triggered to create the virtual relationship between the first communication device and the second communication device by the received invitation acceptance from the second communication device.

2. The method of claim 1, further comprising:
receiving from the first server, a notification that the virtual relationship between the first communication device and the second communication device has been created.

3. The method of claim 1, where the request to the first server further comprises information about a specific type of relationship associated to the second communication device.

4. The method of claim 1, where the first communication device further comprises instructions for causing a processor within a computer disposed in the first communication device to control an execution of the method of claim 1, when said instruction is loaded into the second communication device.

5. A method, performed in a first server, for creating a virtual relationship between a first communication device and a second communication device before the first communication device shares private information with the second communication device, the first communication device including an application with a registered account at the first server, and the second communication device including an application with a registered account at a second, different server, the method comprising:
receiving from the first communication device a request to generate an invitation to create a virtual relationship between the first communication device and the second communication device;
generating the requested invitation associated to the first communication device account;
sending the generated invitation to the first communication device;
receiving an invitation acceptance from the second communication device via the second server, which invitation acceptance comprises the invitation to create a relationship between the first communication device and the second communication device, the invitation being received at the second communication device in a short message service (SMS) from the first communication device; and
creating a relationship between the first communication device and the second communication device, when receiving the invitation acceptance from the second communication device.

6. The method of claim 5, where information about a specific type of relationship associated to the second communication device is included in the request to generate an invitation, and the generated invitation associated to the first communication device account, is further associated to the specific type of relationship associated to the second communication device.

7. The method of claim 5, where the creating a relationship between the first communication device and the second communication device comprises:
receiving a request from the second server, requesting a credential for the second communication device to watch the first communication device user information;
creating the credential for the second communication device to watch first communication device user information; and
sending, to the second server, the requested credential for the second communication device to watch the first communication device user information.

8. The method of claim 5, further comprising:
receiving from the second communication device, a request for invitation details; and
sending a response to the second communication device, the response comprising information about specific type of relationship associated to the second communication device.

9. The method of claim 5, further comprising:
sending a request to the second server, requesting a credential for the first communication device to watch the second communication device user information; and
receiving the requested credential for the first communication device to watch the second communication device user information.

10. The method of claim 5, further comprising:
notifying the first communication device of the creation of the virtual relationship between the first communication device and the second communication device.

11. The method of claim 5, where the first communication device further comprises instructions for causing a processor within a computer disposed in the first communication device to control an execution of the method of claim 5, when said instruction is loaded into the second communication device.

12. A first communication device to have a virtual relationship with a second communication device before sharing private information, the second communication device comprising an application with a registered account at a second server, the first communication device comprising:
an application with a registered account at a first server;
a sending unit to send a request to the first server for generating an invitation to create a virtual relationship between the first communication device and the second communication device,
a receiving unit to obtain from the first server, the requested invitation to create a virtual relationship between the first communication device and the second communication device; and
the sending unit further to send a short message service (SMS) to the second communication device, the SMS comprising the obtained invitation to create a virtual relationship between the first communication device and the second communication device, and an Internet Protocol “IP” link to the first server, to which first server the second communication device can send an invitation acceptance via the second server, and which first server will be triggered to create the virtual relationship between the first communication device and the second communication device by the received invitation acceptance from the second communication device.

13. The first communication device of claim 12, where the receiving unit is further to receive, from the first server, a notification of creation of the virtual relationship between the first communication device and the second communication device created.

14. The first communication device of claim 12, where the request to the first server further comprises information about a specific type of relationship associated to the second communication device.

15. The first communication device of claims 12, where the first communication device is a mobile phone.
